(19) United States
(12) Patent Application Publication
(10) Pub. No.: US 2017/0017892 A1
(43) Pub. Date: Jan. 19, 2017

(54) SAMPLING VARIABLES FROM PROBABILISTIC MODELS

(71) Applicant: ANALOG DEVICES, INC., Norwood, MA (US)

(72) Inventors: JEFFREY G. BERNSTEIN, MIDDLETON, MA (US); DAVID WINGATE, PROVO, UT (US); JOHN REDFORD, ARLINGTON, MA (US)

(73) Assignee: ANALOG DEVICES, INC., NORWOOD, MA (US)

(21) Appl. No.: 15/154,113

(22) PCT Filed: Oct. 15, 2014
(86) PCT No.: PCT/US2014/060691

§ 371 Date: May 13, 2016

Related U.S. Application Data
(60) Provisional application No. 61/891,189, filed on Oct. 15, 2013.

(51) Int. Cl. G06N 7/00

(52) U.S. Cl. CPC G06N 7/005

(57) ABSTRACT

The disclosed apparatus and methods include a reconfigurable sampling accelerator and a method of using the reconfigurable sampling accelerator, respectively. The reconfigurable sampling accelerator can be adapted to a variety of target applications. The reconfigurable sampling accelerator can include a sampling module, a memory system, and a controller that is configured to coordinate operations in the sampling module and the memory system. The sampling module can include a plurality of sampling units, and the plurality of sampling units can be configured to generate samples in parallel. The sampling module can leverage inherent characteristics of a probabilistic model to generate samples in parallel.

### CROSS-REFERENCE TO RELATED APPLICATION

This application claims the benefit of the earlier priority date of U.S. Provisional Patent Application No. 61/891,189, entitled “APPARATUS, SYSTEMS, AND METHODS FOR STATISTICAL SIGNAL PROCESSING,” filed on Oct. 15, 2013, which is expressly incorporated herein by reference in its entirety.

### TECHNICAL FIELD

Disclosed apparatus and methods relate to providing statistical signal processing.

### Description of the Related Art

Statistical signal processing is an important tool in a variety of technical disciplines. For example, statistical signal processing can be used to predict tomorrow's weather and stock price changes; statistical signal processing can be used to plan movements of a robot in a complex environment; and statistical signal processing can also be used to represent noisy, complex data using simple representations.

Unfortunately, statistical signal processing often entails a large amount of computations. Certain computing systems can accommodate such a large amount of computations by performing statistical signal processing on high performance servers in large data centers or on dedicated accelerators tailored to a particular, specialized application. However, these systems are generally expensive to operate. Also, these systems are difficult to design and deploy in consumer products. Therefore, statistical signal processing has not been widely adopted in consumer products.

Therefore, there is a need to provide a flexible framework to accelerate statistical signal processing.

### SUMMARY

In accordance with the disclosed subject matter, apparatus and methods are provided for statistical signal processing.

In some embodiments of the disclosed subject matter, an apparatus includes a reconfigurable sampling accelerator configured to generate a sample of a variable in a probabilistic model. The reconfigurable sampling accelerator can include a sampling module having a plurality of sampling units, wherein a first one of the plurality of sampling units is configured to generate the sample in accordance with a sampling distribution associated with the variable in the probabilistic model; a memory device configured to maintain a model description table for determining the sampling distribution for the variable in the probabilistic model; and a controller configured to retrieve at least a portion of the model description table from the memory device, determine the sampling distribution based on the portion of the model description table, and provide the sampling distribution to the sampling module to enable the sampling module to generate the sample that is statistically consistent with the sampling distribution.

In some embodiments, the first one of the plurality of sampling units is configured to generate the sample using a cumulative distribution function (CDF) method.

In some embodiments, the first one of the plurality of sampling units is configured to compute a cumulative distribution of the sampling distribution, determine a random value from a uniform distribution, and determine an interval, corresponding to the random value, from the cumulative distribution, wherein the determined interval is the sample generated in accordance with the sampling distribution.

In some embodiments, the reconfigurable sampling accelerator is configured to retrieve a one-dimensional slice of a factor table associated with the model description table from the memory device, and compute a summation of the one-dimensional slice to determine the sampling distribution.

In some embodiments, the reconfigurable sampling accelerator is configured to compute the summation of the one-dimensional slice using a hierarchical summation block tree.

In some embodiments, a second one of the plurality of sampling units is configured to generate a sample using a Gumbel distribution method.

In some embodiments, the second one of the plurality of sampling units comprises a random number generator, and the second one of the plurality of sampling units is configured to receive negative log probability values corresponding to a plurality of states in the sampling distribution, generate a plurality of random numbers, one for each of the plurality of states, using the random number generator, determine Gumbel distribution values based on the plurality of random numbers, compute a difference between the negative log probability values and the Gumbel distribution values for each of the plurality of states, and determine a state whose difference between the negative log probability value and the Gumbel distribution value is minimum, wherein the state is the sample generated in accordance with the sampling distribution.

In some embodiments, the second one of the plurality of sampling units is configured to receive the negative log probability values in an element-wise streaming manner.

In some embodiments, the second one of the plurality of sampling units is configured to receive the negative log probability values in a block-wise streaming manner.

In some embodiments, the random number generator comprises a linear feedback shift register (LFSR) sequence generator.

In some embodiments, the controller is configured to determine an order in which variables in the probabilistic model are sampled.

In some embodiments, the controller is configured to store the model description table in an external memory when a size of the model description table is larger than a capacity of the memory device in the reconfigurable sampling accelerator.

In some embodiments, the memory device comprises a plurality of memory modules, and each of the plurality of memory modules is configured to maintain a predetermined portion of the model description table to enable the plurality of sampling units to access different portions of the model description table simultaneously.

In some embodiments, each of the plurality of memory modules is configured to maintain a factor table corresponding to a factor within the probabilistic model.

In some embodiments, the memory device is configured to store the factor table multiple times in a plurality of representations, wherein each representation of the factor table stores the factor table in a different bit order so that each representation of the factor table has a different variable dimension that is stored contiguously.

In some embodiments, the controller is configured to identify one of the plurality of representations of the model description table to be used by the sampling unit to improve a rate at which the model description table is read from the memory device.

In some embodiments, the memory device comprises a scratch pad memory device configured to maintain intermediate results generated by the first one of the plurality of sampling units while generating the sample.

In some embodiments, the scratch pad memory device and the first one of the plurality of sampling units are configured to communicate via a local interface.

In some embodiments, the memory device is configured to maintain the model description table in a raster scanning order.

In some embodiments of the disclosed subject matter, a method includes retrieving, by a controller from a memory device in a reconfigurable sampling accelerator, at least a portion of a model description table associated with at least a portion of a probabilistic model; computing, at the controller, a sampling distribution based on the portion of the model description table; identifying, by the controller, a first one of a plurality of sampling units in a sampling module for generating a sample of a variable in the probabilistic model; and providing, by the controller, the sampling distribution to the first one of a plurality of sampling units to enable the first one of a plurality of sampling units to generate the sample that is statistically consistent with the sampling distribution.

In some embodiments, the method includes computing a cumulative distribution of the sampling distribution, determining a random value from a uniform distribution, and determining an interval, corresponding to the random value, from the cumulative distribution, wherein the determined interval is the sample generated in accordance with the sampling distribution.

In some embodiments, the method includes receiving negative log probability values corresponding to a plurality of states in the sampling distribution, generating a plurality of random numbers, one for each of the plurality of states, using the random number generator, determining Gumbel distribution values based on the plurality of random numbers, computing a difference between the negative log probability values and the Gumbel distribution values for each of the plurality of states, and determining a state whose difference between the negative log probability value and the Gumbel distribution value is minimum, wherein the state is the sample generated in accordance with the sampling distribution.

In some embodiments, the method includes receiving the negative log probability values in an element-wise streaming manner.

In some embodiments, the method includes receiving the negative log probability values in a block-wise streaming manner.

In some embodiments, the method includes determining, at the controller, an order in which variables in the probabilistic model are sampled.

In some embodiments, the method includes storing the model description table in an external memory when a size of the model description table is larger than a capacity of the memory device in the reconfigurable sampling accelerator.

In some embodiments, the method includes maintaining a first portion of the model description table in a first one of a plurality of memory modules in the memory device; and maintaining a second portion of the model description table in a second one of the plurality of memory modules in the memory device, thereby enabling the plurality of sampling units to access different portions of the model description table simultaneously.

In some embodiments, the method includes maintaining, in the memory device, a factor table in the model description table multiple times in a plurality of representations, wherein each representation of the factor table stores the factor table in a different bit order so that each representation of the factor table has a different variable dimension that is stored contiguously.

In some embodiments, the method includes maintaining the model description table in the memory device in a raster scanning order.

There has thus been outlined, rather broadly, the features of the disclosed subject matter in order that the detailed description thereof that follows may be better understood, and in order that the present contribution to the art may be better appreciated. There are, of course, additional features of the disclosed subject matter that will be described hereinafter and which will form the subject matter of the claims appended hereto.

### BRIEF DESCRIPTION OF THE DRAWINGS

Various objects, features, and advantages of the disclosed subject matter can be more fully appreciated with reference to the following detailed description of the disclosed subject matter when considered in connection with the following drawings, in which like reference numerals identify like elements.

FIG. 1 illustrates an example of a probabilistic model represented as a graphical model.

FIG. 2 illustrates a computing device with a reconfigurable sampling hardware accelerator in accordance with some embodiments.

FIG. 3 illustrates a process of generating a sample using a reconfigurable accelerator in accordance with some embodiments.

FIGS. 4A-4B illustrate a one-dimensional slice of a three-dimensional factor table in accordance with some embodiments.

FIG. 5 illustrates a summation computation module having distributed adders in accordance with some embodiments.

FIG. 6 illustrates how a sampling unit generates a sample using a cumulative distribution function (CDF) method in accordance with some embodiments.

FIG. 7 illustrates an operation of a sampling unit in a streaming mode in accordance with some embodiments.

FIG. 8 is a block diagram of a computing device in accordance with some embodiments.

### DETAILED DESCRIPTION

In the following description, numerous specific details are set forth regarding the apparatus and methods of the disclosed subject matter and the environment in which such apparatus and methods may operate in order to provide a thorough understanding of the disclosed subject matter. It will be apparent to one skilled in the art, however, that the disclosed subject matter may be practiced without such specific details, and that certain features, which are well known in the art, are not described in detail in order to avoid complication of the subject matter of the disclosed subject matter. In addition, it will be understood that the examples provided below are exemplary, and that it is contemplated that there are other apparatus and methods that are within the scope of the disclosed subject matter.

Statistical inference is an aspect of statistical signal processing. Statistical inference is a process of drawing conclusions from data samples that are subject to random variations. The random variations can be caused by inherent uncertainties associated with the samples; the random variations can be caused by errors associated with observing the samples.

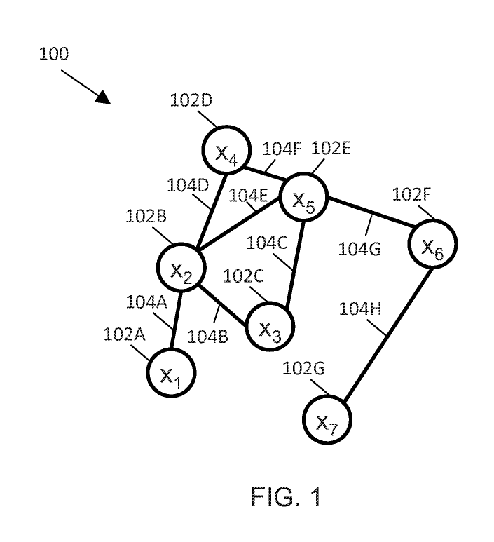

Oftentimes, a statistical inference problem can be defined using a probabilistic model. A probabilistic model can include a graphical model, which is a graph denoting conditional dependencies between random variables. FIG. 1 illustrates an example of a graphical model. The graphical model 100 includes a plurality of nodes 102A-102G and a plurality of edges 104A-104H. Each node 102 represents a random variable and an edge 104 between nodes 102 represents a conditional dependence structure between the nodes 102. One or more nodes 102 in the graphical model 100 can generate samples in accordance with the statistical model defined by the graphical model 100.

Statistical inference engines can use samples generated in accordance with the graphical model 100 to draw inferences about the nodes 102 in the graphical model 100. For example, statistical inference engines can infer, based on the samples generated by (or drawn from) the nodes 102, the most likely state of the nodes 102 in the graphical model 100. Oftentimes, this process can involve drawing samples from the graphical model 100. However, because of complex dependencies between nodes in the graphical model 100, it is oftentimes computationally challenging to draw samples in accordance with the statistical model defined by the graphical model 100.

Therefore, statistical inference engines often use an approximate data sampling technique, instead of an exact data sampling technique, to generate samples from the graphical model 100. One of the popular approximate data sampling techniques includes Markov Chain Monte Carlo (MCMC) sampling methods. The goal of an MCMC sampling method is to generate random samples from the underlying probability model that the graphical model represents. These methods generally involve generating a random sequence of samples in a step-by-step manner, where samples from the present step can depend on samples from the previous step.

One of the most popular MCMC sampling methods is a Gibbs sampling method. A basic Gibbs sampling has a characteristic that only one sample from one node of the graphical model 100 is sampled at a time. In other words, on each successive step, a value of only one node in the graphical model changes from the previous step—all other samples remain unchanged. Over many such steps, a Gibbs sampling module can eventually update all nodes in the graphical model 100, typically a large number of times.

Unfortunately, as discussed further below, a Gibbs sampling method can be computationally expensive, as the Gibbs sampling method generates a large number of samples over many iterations. Furthermore, a Gibbs sampling method can often use a high memory bandwidth because the Gibbs sampling method often uses a sizeable model description table to generate samples. Therefore, a Gibbs sampling method is often slow to implement on computing devices.

Certain computing devices address these issues by using a hardware accelerator that is tailored to a particular application of Gibbs sampling. For example, the Gibbs sampling accelerator can have a plurality of sampling units arranged in accordance with at least a portion of the graphical model of a particular application. This way, the Gibbs sampling accelerator can generate samples in parallel for the particular portion of the graphical model or other portions of the graphical model having the identical structure as the one modeled by the sampling units. However, this Gibbs sampling accelerator cannot be used to generate samples for other portions of the graphical model whose structures differ from the one modeled by the sampling units. Therefore, the efficacy of this Gibbs sampling accelerator can be limited.

The disclosed apparatus and methods can include a reconfigurable sampling accelerator that can be adapted to a variety of target applications and probabilistic models. The reconfigurable sampling accelerator can be configured to generate a sample for a variable of a graphical model using a variety of sampling techniques. For example, the reconfigurable sampling accelerator can be configured to generate a sample using a Gibbs sampling technique, in which case the reconfigurable sampling accelerator can be referred to as a reconfigurable Gibbs sampling accelerator. As another example, the reconfigurable sampling accelerator can be configured to generate a sample using other MCMC sampling methods, such as the Metropolis-Hastings method, a slice sampling method, a multiple-try Metropolis method, a reversible jump method, and a hybrid Monte-Carlo method.

The reconfigurable sampling accelerator can include a sampling module, a memory system, and a controller that is configured to coordinate operations in the sampling module and the memory system. The reconfigurable sampling accelerator can be different from a traditional accelerator in a computing system because two outputs of the reconfigurable sampling accelerator for the same input do not need to be deterministically identical, as long as the outputs of the reconfigurable sampling accelerator for the same input are statistically consistent (or at least approximately statistically consistent) over multiple iterations. The reconfigurable sampling accelerator can be considered to generate samples that are statistically consistent with an underlying sampling distribution when a large number of samples generated by the reconfigurable sampling accelerator collectively have characteristics of the underlying sampling distribution. For example, the reconfigurable sampling accelerator can be said to generate statistically consistent samples when a distribution of the samples is substantially similar to the underlying sampling distribution.

In some embodiments, the sampling module can include a plurality of sampling units, and the plurality of sampling units can be configured to generate samples in parallel. The sampling module can leverage inherent characteristics of a graphical model to generate samples in parallel.

In some embodiments, the controller can be configured to schedule the sampling operations of the plurality of sampling units so that as many sampling units are operational as possible at any given time, e.g., without idling sampling units. This way, the throughput of the sampling module can be increased significantly. Also, because the controller can schedule the operation of the sampling units, the sampling units can be adapted to draw samples from any types of graphical models. Therefore, the sampling module is reconfigurable based on the graphical model of interest.

In some embodiments, the memory system can be configured to maintain a model description table that represents the statistical model defined by the graphical model. A model description table can be indicative of a likelihood that nodes in a graphical model take a particular set of values. For example, the model description table can indicate that the nodes [x₁, x₂, x₃, x₄, x₅, x₆, x₇] of the graphical model 100 take the values [0,1,1,0,1,0,1] with a probability of 0.003. In some cases, values in the model description table can be probability values. In other cases, values in the model description table may be merely indicative of probability values. For example, values in the model description table can be proportional to probability values; a logarithm of probability values; an exponentiation of probability values; or any other transformation of probability values. Yet, in other cases, values in the model description table may be unrelated to probability values.

In some embodiments, a graphical model can include one or more factors. A statistical model of a factor in a graphical model can be represented using a factor table. In some cases, the union of factor tables corresponding to the one or more factors can comprise at least a portion of an model description table for the graphical model. When a graphical model has only a single factor, then the model description table can be identical to the factor table corresponding to the single factor.

In some embodiments, one or more factors in a model description table can share one of the plurality of factor tables in the model description table. In other words, one of the plurality of factor tables can be associated with one or more factors. In some embodiments, a single factor table can represent a statistical model of two or more factors in a graphical model.

In some embodiments, a node (e.g., a variable) in a graphical model can be connected to more than one factor. In this case, the memory system can be configured to maintain a separate factor table for each factor. The likelihood that the neighboring nodes take on the particular values can be obtained from combining an appropriate portion (e.g., a slice) from each of these factor tables.

In some embodiments, the memory system can be configured to provide at least a portion of the model description table to the sampling module so that the sampling module can generate samples based on the received portion of the model description table. In some embodiments, the portion of the model description table used by the sampling module to generate samples can include a portion of a factor table or a plurality of factor tables. For example, the memory system can provide a portion of a factor table, for example a one-dimensional slice of a factor table, to the sampling module so that the sampling module can generate samples based on the portion of the factor table. In some instances, a portion of a factor table can include an entire factor table. In another example, the memory system can provide a plurality of factor tables to the sampling module so that the sampling module can generate samples based on the plurality of factor tables.

In some cases, the size of an model description table can be large. For example, when the domain of a node xᵢ is D , then the size of the model description table can be D^{N}, where N is the number of variables in a graphical model represented by the model description table (or the number of variables coupled to a factor represented by the model description table). Therefore, the memory system can be designed to facilitate a rapid transfer of a large model description table.

In some cases, the sampling module may not use the entire model description table. For example, as discussed further below, the sampling module may only use a one-dimensional slice of a factor table in the model description table. Therefore, in some embodiments, the bandwidth specification of the memory system can be relaxed; the memory system can be designed to facilitate a rapid transfer of a one-dimensional slice of a factor table in the model description table, rather than the entire factor table in the model description table.

### Gibbs Sampling

Gibbs sampling is a common technique for statistical inference. Gibbs sampling can be used to generate samples of a probabilistic model that include more than one variable—typically a large number of variables. If Gibbs sampling is performed correctly, Gibbs sampling can generate samples that have the same statistical characteristics as the underlying graphical model.

In Gibbs sampling, the order that variables are updated (also referred to as a scan order) may be deterministic or random. However, the scan order adheres to a specification that in the long run, all variables are updated approximately the same number of times. In each step of Gibbs sampling, the sampling module is configured to choose a new value for one variable, which is referred to as a sampling variable.

In Gibbs sampling, the choice of a new value for the sampling variable can be randomized. However, this randomness can take a specific form. Specifically, suppose that a probabilistic model has n variables, X₁, . . . , Xₙ, and that the variables are related by a joint probability distribution π(X₁, . . . ,Xₙ). Furthermore, suppose that, at a time instance t, the n variables, X₁, . . . Xₙhave values x₁^{t}, . . . , xₙ^{t}, and that the sampling module decides to update the Xᵢ in the next time instance t+1. In this case, the sampling module is configured to choose a new value, xᵢ^{t+1}, based on the following sampling distribution:

$$\begin{matrix}p ( {x}_{i}^{t + 1} ) = π ( {X}_{i} \vert {x}_{j \neq i}^{t} ) \\ = \frac{π ( {x}_{1}^{t} , … {x}_{i}^{t + 1} , … {x}_{n} )}{{\sum }_{{x}_{i}^{′}} π ( {x}_{1}^{t} , … {x}_{i}^{t + 1} , … {x}_{n} )} ( 1 b )\end{matrix} \qquad ( 1 a )$$

The sampling distribution is a conditional probability (associated with the model distribution, π) of the variable Xᵢ in accordance with the model distribution, given the previous values of all variables other than the variable Xᵢ. All other variables remain unchanged on this step. In other words, x_{j≠1}^{t+1}=x_{j≠i}^{t}.

In some cases, a graphical model can be represented as a factor graph. A factor graph is a bipartite graph representing the factorization of a function. If a graphical model can be factored, then the sampling distribution can be further simplified. In particular, variables that are not a part of the Markov blanket of Xᵢ can be ignored due to the conditional independencies implied by the factor graph. Specifically, if the neighboring factors of Xᵢ directly connect only to a subset of variables, Nᵢ, then this implies:

p_{π}(Xᵢ|x_{j≠i}^{t})=π(Xᵢ|x_{j∈N}_{ᵢ}^{t}) (2)

More specifically, if π factors as π(X₁, . . . Xₙ)=πᵢ(Xᵢ, X_{j∈N}_{ᵢ})πᵢ′(X_{k≠i}), then

$$\begin{matrix}p ( {x}_{i}^{t + 1} ) = \frac{{π}_{i} ( {x}_{i}^{t + 1} , ) {π}_{{i}^{′}} ( {x}_{k \neq i}^{t} )}{{\sum }_{{x}_{i}^{′}} {π}_{i} ( {x}_{1}^{t + 1} , ) {π}_{{i}^{′}} ( {x}_{k \neq i}^{t} )} \\ = \frac{{π}_{i} ( {x}_{1}^{t + 1} , )}{{\sum }_{{x}_{i}^{′}} {π}_{i} ( {x}_{1}^{t + 1} , )} ( 3 b )\end{matrix} \qquad ( 3 a )$$

In some cases, the probability distribution π may not be known directly, but a function f that is proportional to the probability distribution π may be known. In this case, the unnormalized function f can be used to compute the sampling distribution as follows:

$$p ( {x}_{i}^{t + 1} ) = \frac{{f}_{i} ( {x}_{i}^{t + 1} , )}{{\sum }_{{x}_{i}^{′}} {f}_{i} ( {x}_{i}^{t + 1} , )} \qquad ( 4 )$$

The function fᵢ corresponds to the product of the factors that directly connect to variable Xᵢ.

### Gibbs Sampling—Sampling Discrete Variables

When a graphical model is defined over discrete variables, where the underlying probability model is available in the form of a model description table, then the sampling module can be configured to directly compute the probability p(xᵢ^{t+1}) based on Equation 4, and generate a sample according to this probability p(xᵢ^{t+1}).

The sampling module can use one of several sampling methods to generate the sample. In some embodiments, the sampling module is configured to use a sampling method that is efficient even when the sampling module draws only one sample from the sampling distribution because the sampling module is configured to update the sampling distribution after generating each sample.

In some embodiments, the sampling module can use a cumulative distribution function (CDF) method to draw a sample from a sampling distribution. To this end, the sampling module can compute a cumulative distribution C(xᵢ^{t+1}) from a sampling distribution p(xᵢ^{t+1}). When Xᵢ is a discrete random variable, the sampling distribution and the cumulative distribution can be indexed using a domain index k. For example, when a domain index ranges from 0 to K-1, a sampling distribution p_{[k]} is an array of K values, where each domain index is associated with a probability pₖ. Based on this construction, the cumulative distribution, Cₖ, can be computed as follows:

$${C}_{k} = \{ \begin{matrix}0 & if k = 0 \\ {\sum }_{j = 0}^{k - 1} {p}_{k} & if 1 \leq k \leq K - 1\end{matrix} \qquad ( 5 )$$

Because the values Cₖ form a non-decreasing sequence, the cumulative distribution Cₖ can be considered as points along a real line from 0 to 1. The size of the k^{th} interval (e.g., an interval between the (k−1)^{th} point and the k^{th} point) is equal to pₖ. Therefore, when a random value between 0 and 1 is drawn from a uniform distribution, the probability of falling into the k^{th} interval of the cumulative distribution Cₖ equals pₖ.

In some embodiments, the above principle can be used to draw a sample from a sampling distribution. For example, the sampling module can draw a sample from the sampling distribution pₖ by drawing a random value between 0 and 1 from a uniform distribution and determining the interval of the cumulative distribution Cₖ into which the random value falls.

More specifically, the sampling module can determine a random value U between 0 and 1 from a uniform distribution. Then the sampling module can generate the sample by determining the largest value of k for which Cₖ≦U:

$${k}_{d} = {arg max}_{k} \{ {C}_{k} \leq U \}$$

The largest index value k_{d} is the generated sample.

In some embodiments, the sampling module can determine the largest value k_{d} using a linear search technique. For example, the sampling module can progress from 0 to K until the condition Cₖ≦U is no longer satisfied. The linear search technique can take O(K) operations. In other embodiments, the sampling module can determine the largest value k_{d} using a binary search technique, which can take O(log(K)) operations.

The CDF sample generation method is efficient in some respects because the CDF sample generation method involves only one random value and simple computations. However, the CDF sample generation method may use a large storage space or a large memory bandwidth to generate samples. The CDF sample generation method can involve multiple passes over data (e.g., the CDF sample generation method may need to run through the data more than once to produce a sampled value). For example, the CDF sample generation method can convert a slice of a factor table to the probability domain and sum the values in the slice (for normalization) in a first pass. Then, subsequently, the CDF sample generation method can perform a second pass through the slice in order to decide the bin to which the sample would fall. In some embodiments, the CDF sample generation method stores the slice of the factor table in a local storage so that the slice of the factor table does not need to be fetched from a model description table memory or an external memory in every pass. Because the size of the slice of the factor table is proportional to the size of the domain of the variable, the CDF generation method may need a local storage device with a large storage space. In other embodiments, the CDF sample generation method retrieves the slice of the factor table from a model description table memory or an external memory in every pass. In this case, the CDF sample generation method would consume a large memory bandwidth to retrieve the slice of the factor table. Therefore, the CDF sample generation method may use a large storage space or a large memory bandwidth to generate samples.

In some embodiments, the model description table can maintain values in the log domain. In particular, the model description table can maintain a negative log probability of the distribution associated with the graphical model. In this case, the sampling module can be configured to compute an exponent of the values in the model description table to get to the probability domain. Subsequently, the sampling module can normalize the exponent values to generate a probability distribution. The normalization operation can include a summation operation that sums the probability values. While this summation operation can be performed at the same time as the cumulative distribution, in many embodiments the summation operation is completed prior to generating a sample, as discussed above. Specifically, when the model description table includes energy values, Eₖ (negative log of the unnormalized probabilities), the sampling module can compute an unnormalized cumulative distribution:

$${\tilde{C}}_{k} = \{ \begin{matrix}0 & if k = 0 \\ {\sum }_{j = 0}^{k} exp ( - {E}_{j} ) & if 1 \leq k \leq K - 1\end{matrix} \qquad ( 6 )$$

Subsequently, the sampling module can choose the largest value of k such that \tilde{C}ₖ≦U\tilde{C}ₖ.

In some embodiments, when variables can only take a binary value, the sampling module can use a variant of the CDF method to generate a data item in a simpler manner. In this case, suppose that the model description table includes energy values E₀ and E₁. In this case, the sampling module can sample a random value U from a uniform distribution, and find the sample value k^{*} such that:

$${k}^{*} = \{ \begin{matrix}0 & if U ( 1 + exp ( {E}_{1} - {E}_{0} ) ) > 1 , \\ 1 & otherwise\end{matrix} \qquad ( 7 )$$

In some embodiments, the sampling module can use a Gumbel distribution method to generate a sample. In this case, the sampling module is referred to be operating in a streaming mode. While the CDF method is efficient, it requires multiple passes over the data, which may render the CDF method slow. This issue can be addressed using the Gumbel distribution method. The Gumbel distribution method allows the sampling module to generate a sample from a distribution in a streaming mode, where only one pass over the data is required. Additionally, the Gumbel distribution method can directly use unnormalized energy values in the log domain (e.g., the negative log of the unnormalized probability values) without the exponentiation operation, as in the CDF method.

A Gumbel distribution can be defined as a cumulative distribution function:

F(x)=e^{-e}^{^{−x}} (8)

Similar to the CDF method above, the sampling module can generate a sample from the Gumbel distribution by choosing a random value, U, between 0 and 1, from a uniform distribution, and computing the inverse of the cumulative distribution function, F. That is, given U, the sampling module can compute a Gumbel distribution value, G, from the Gumbel distribution as:

$$\begin{matrix}G = {F}^{- 1} ( U ) \\ = - log ( - log ( U ) ) ( 9 b )\end{matrix} \qquad ( 9 a )$$

This operation is repeated for each possible state (e.g., each of the K possible states) in the variable's domain.

Now, given a set of K Gumbel distribution values from a Gumbel distribution, Gₖ for k∈{0 . . . K−1}, and given a set of K energy values (negative log of the unnormalized probabilities), Eₖ, the sampling module can find a sample k* such that:

$${k}^{*} = {arg min}_{k} \{ {E}_{k} - {G}_{k} \} \qquad ( 10 )$$

The resulting value, k*, is sampled according to the normalized probability distribution corresponding to the energy values, Eₖ:

$${p}_{k} = \frac{exp ( - {E}_{k} )}{{\sum }_{{k}^{′}} exp ( - {E}_{{k}^{′}} )} \qquad ( 11 )$$

In some cases, the sampling module can use the Gumbel distribution method to generate a sample in a streaming mode in which the negative log probability values corresponding to possible states are received one at a time. For example, given a stream of values, Eₖ and Gₖ, the sampling module can generate a sample in a streaming mode by maintaining (1) a running minimum value of Eₖ−Gₖ and (2) an index k⁺ corresponding to the minimum value of Eₖ−Gₖ over streamed values Eₖ and Gₖ:

$${k}^{+} = {arg min}_{k} \{ {E}_{k} - {G}_{k} \} , \\ k = 0 … {k}^{t} \qquad ( 12 )$$

where k^{t} is the current index in the streamed values Eₖ and Gₖ. This operation does not involve storing previous values of Eₖ or Gₖ (e.g., Eₖ or Gₖ for k=0 . . . k^{t}−1. Therefore, in the streaming mode, the sampling module does not need to store the entire Eₖ and/or Gₖ arrays. As a result, the sampling module can generate a sample from a distribution for a variable of arbitrarily large domain size using a small amount of memory.

One disadvantage of the Gumbel distribution method is that the sampling module has to generate a new uniform random value for each of the K elements in the domain. Therefore, compared to the CDF method, the Gumbel distribution method may use more random numbers that are generated based on a uniform distribution.

### Gibbs Sampling—Sampling Continuous Variables

In some embodiments, the sampling module can sample from a graphical model for continuous variables. In the case of continuous variables, sampling can be more difficult than for discrete variables. A sampling method for sampling from continuous variables can fall into one of two basic categories:
Sampling from parameterized conjugate distributions.
Sampling from arbitrary distributions where the value of the unnormalized probability density function (and possibly other functions of the PDF) can be computed for specific values of the variable.

The sampling module can use the parameterized conjugate distributions only in specific circumstances where all of the factors connecting to a sampling variable have an appropriate form, and where the particular sampling unit for that distribution has been implemented. Therefore, the sampling module may need a plurality of sampling units where each sampling unit is configured for sampling from one of the parameterized conjugate distributions. For example, the sampling module can include a sampling unit for a Normal distribution, a Gamma distribution, and/or a Beta distribution.

The sampling module can use more general sampling methods to sample from continuous variables. Examples of this type of sampling include Slice Sampling and Metropolis-Hastings. In general, these methods rely on the ability to compute the value of the probability density function (PDF) at specific variable values (and possibly computing other functions of the PDF, such as derivatives). While these methods are generic, the computation of PDF values involves expressing specific factors in a computable form when creating the model, and repeatedly performing this computation while sampling. For example, for a continuous variable, Xᵢ, and fixed values of the neighboring variables, x_{j∈N}_{ᵢ}, the value of fᵢ(xᵢ, x_{j∈N}_{ᵢ}) is not known for all values of xᵢ, xᵢ simultaneously, but can be computed for particular values of xᵢ. In the log domain, assuming fᵢ is further factored into multiple factors, the sampling module can compute the value of each of these sub-factors and simply sum the result. The particular sampling algorithms use the value of fᵢ(xᵢ, x_{j∈N}_{ᵢ}) in different ways.

### Gibbs Sampling—Handling Deterministic Factors

In its basic form, Gibbs sampling may not be able to handle factors that are deterministic or highly sparse. When a sampling variable is connected to a deterministic factor, then conditioned on fixed values of the neighboring variables, only one value may be possible for the sampling variable. This means that, when generating a sample for a sampling variable, the one possible value will always be chosen, preventing the variable value from ever changing. When this occurs, the samples generated by Gibbs sampling are not valid samples from the underlying graphical model.

One form of a deterministic factor is a factor that corresponds to a deterministic function. This means that variables connected to a sampling variable can be represented as input variables and an output variable. In this case, for each possible combination of values of the input variables, there is exactly one possible value for the output variable. Such a factor can be referred to as a deterministic-directed factor, since it can be expressed as a sampling distribution of the output variable given the input variables. In such cases, the sampling module can use the knowledge of the functional form of the factor to avoid the problems with Gibbs sampling.

Specifically, the sampling module can use a generalization of Gibbs sampling called block-Gibbs sampling, in which the sampling module updates more than one variable at a time. For deterministic-directed factors, the sampling module can perform this operation in a very specific way. First of all, for each variable, the sampling module can identify any other variables that depend on it in a deterministic way. In other words, for each variable, the sampling module can identify variables that are outputs of deterministic-directed factors to which the variable is an input. The sampling module can extend this operation recursively to include all variables that depend on those variables as well. For each such variable, the sampling module can identify a tree of deterministically dependent variables.

Subsequently, when performing Gibbs sampling, the sampling module can exclude those variables that are deterministically dependent on other variables from the scan order. When the sampling module resamples a variable that has deterministic dependents, the sampling module can simultaneously modify the values of the entire tree of dependent variables by explicitly computing the deterministic function corresponding to the factor.

In order to generate samples for a variable, the sampling module can use neighboring factors. In this case, the sampling module can expand the set of factors that is considered neighbors to include the neighboring factors of all of the variables in the dependent tree of variables. Using this approach, the sampling module can generate samples of most graphical models with deterministic-dependent factors. One exception is when an output variable of a factor connects to no other factors (e.g., the factor is an isolated factor), but whose value is known precisely. In this case, the sampling module can relax the requirement that the output of the sampling unit for the isolated factor has to be equivalent to the known value. Instead, the sampling unit can assume, for example, that the value of the isolated factor is subject to an observation noise.

For deterministic or sparse factors that are not deterministic-directed, the sampling module can use other sample generation methods. For example, the sampling module can use other forms of block-Gibbs updates. As another example, the sampling module can smooth a factor. The smoothing operation can include (1) selecting a factor that is zero (in probability domain, positive infinity in the log domain) for a large portion of possible values of the connected variables, and (2) make them non-zero (in probability domain) by smoothing them relative to nearby non-zero values (nearby in the sense of the multidimensional space of variable values). This can be applicable when the discrete variable values have a numeric interpretation, so that the concept of “nearby” is reasonably well defined.

In some embodiments, when a factor is smoothed, the sampling module can be configured to adjust the sampling process as the sampling module progresses through the sampling operations. For example, the sampling module can be configured to gradually lower a temperature of the graph (or the particular factor of interest) toward zero, where the inverse of the temperature corresponds to a multiplicative constant in the exponent, which corresponds to multiplying these values by a constant in the log domain. Therefore, to lower the temperature of the graph, the sampling module can be configured to multiply log-domain values of the slices of a factor table with a time-varying constant. This multiplication can occur before or after summing the log-domain values of the slices.

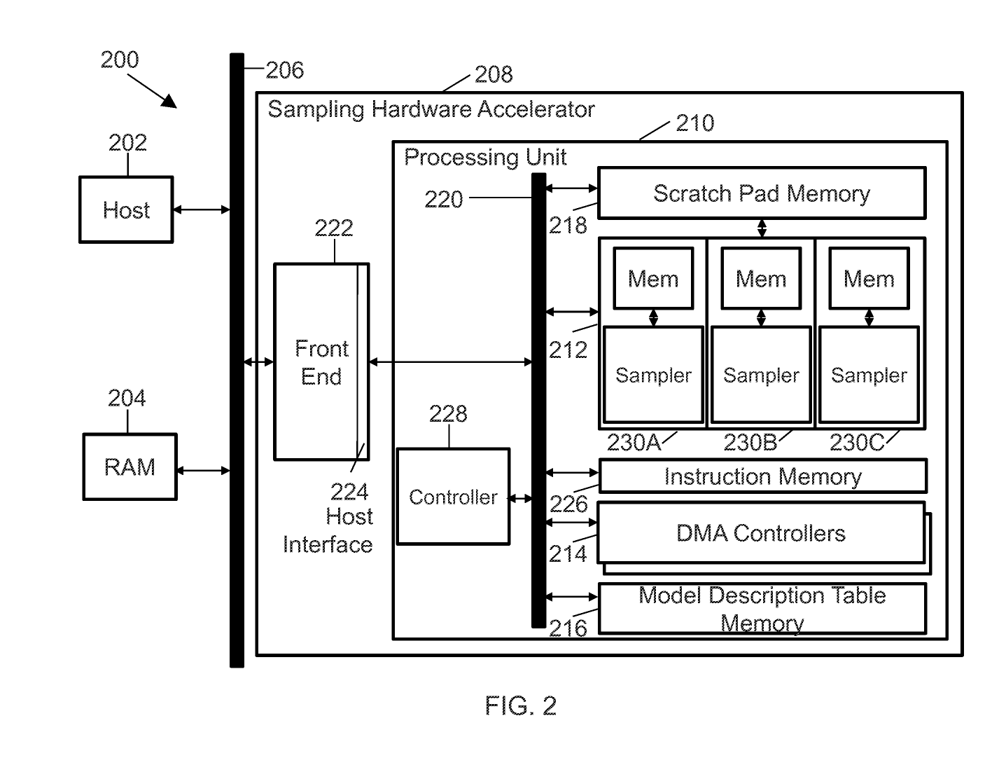

In some embodiments, Gibbs sampling can be performed using a computing device with a reconfigurable sampling hardware accelerator. FIG. 2 illustrates a computing device with a reconfigurable sampling hardware accelerator in accordance with some embodiments. The computing device 200 includes a host 202, external memory 204, a system interface 206, and a reconfigurable sampling hardware accelerator 208.

The reconfigurable accelerator 208 includes a special purpose processor specifically designed to perform computation for Gibbs sampling. The reconfigurable accelerator 208 can be configured to operate in parallel with a general-purpose processor and other accelerators. The reconfigurable accelerator 208 is programmable in that it can perform this computation for an arbitrary graphical model. The reconfigurable accelerator 208 can include a processing unit 210. The processing unit 210 can include a sampling module 212, one or more direct memory access (DMA) controllers 214, model description table memory 216, scratch pad memory 218, instruction memory 226, a controller 228, and an internal interface 220. The computing device 208 also includes a front-end interface 222 that mediates communication between the host 202, the external memory 204, and the processing unit 210. The front-end interface 222 can include a host interface 224.

The host system 202 can be configured to analyze a problem graphical model and determine a sequence of computations for generating a sample from the graphical model. The analysis can be accomplished, for example, by using an application-programming interface (API) and a compiler designed specifically for the reconfigurable accelerator 208. Based on the determined sequence of computations, the host system 202 transfers high level instructions into the external memory 204 along with the necessary model description table if not already resident (e.g., from an earlier computation or from another prior configuration). The host system 202 can include a processor that is capable of executing computer instructions or computer code. The processor can be implemented in hardware using an application specific integrated circuit (ASIC), a programmable logic array (PLA), digital signal processor (DSP), field programmable gate array (FPGA), or any other integrated circuit.

The front-end interface 222 is configured to retrieve high level instructions from the external memory 204 using the direct memory access (DMA) controllers 214 and provide them to the sampling module 212 via the host interface 224. The high-level instructions can include a variable length very long instruction word (VLIW) instruction. The front-end interface 222 is also configured to read the model description table from the external memory 204 and provide the values to the sampling module 212 and the model description table memory 216 via the host interface 224.

The sampling module 212 can include a plurality of sampling units 230A-230C in which each of the sampling units 230A-230C can independently generate samples in accordance with a sampling distribution. In some embodiments, the sampling units 230A-230C can be configured to generate samples in parallel.

In some cases, the sampling units 230A-230C can be configured to take advantage of inherent characteristics of Gibbs sampling to facilitate parallel sample generation. In particular, the sampling units 230A-230C can be configured to leverage the Markov property of the graphical model to facilitate parallel sample generation. For example, in a graphical model 100, a sampling node is independent of other nodes in the graphical model 100 when the sampling node is conditioned on the sampling node's Markov blanket (e.g., a set of nodes composed of the sampling node's parents, children, and children's other parents.) For example, in FIG. 1, the node X₇ 102G is independent of nodes X₁, X₂,X₃,X₄,X₅ 102A-102E when the node X₇ 102G is conditioned on the value of the node X₆ 102F. Therefore, the sampling module 212 can generate samples for the node X₇ 102G independently of nodes X₁,X₂,X₃,X₄,X₅ 102A-102E by fixing the value of the node X₆ 102F.

The sampling module 212 can be configured to receive a model description table, indicating a likelihood of a configuration of variables in the graphical model 100. In some embodiments, the model description table can be maintained in the external memory 204. When the sampling module 212 is instructed to generate a sample, the sampling module 212 can request the external memory 204 to provide a portion of the model description table needed to generate the sample. In some cases, the sampling module 212 can receive data from the external memory 204 using a memory interface, such as a dynamic random access memory (DRAM) interface, that is wide and high-speed. In some embodiments, the model description table can be maintained in the model description table memory 216. When the sampling module 212 is instructed to generate a sample, the sampling module 212 can request the model description table memory 216 to provide a portion of the model description table needed to generate the sample.

In some cases, when the model description table is small enough to fit in the model description table memory 216, the model description table memory 216 can be configured to maintain the entire model description table. In other cases, when the model description table is too large to fit in the model description table memory 216, the model description table memory 216 can be configured to maintain a portion of the model description table. The portion of the model description table can be selected based on a likelihood of being used by the sampling module 212.

In some embodiments, the model description table memory 216 can include a memory bank having a plurality of memory modules. Each memory module can be configured to maintain a portion of the model description table. In some embodiments, the portions of the model description table can be scattered across the plurality of memory modules so that sampling units 230A-230C can independently access the model description table from different memory modules without conflicts (e.g., without waiting for other sampling units to complete the memory access). In some embodiments, the model description table memory 216 can be organized into one or more layers of the model description table memory 216 hierarchy.

In some embodiments, the sampling module 212 can use the scratch pad memory 218 to store and retrieve intermediate results during the sample generation. To facilitate a rapid transfer of data between the sampling module 212 and the scratch pad memory 218, the sampling module 212 and the scratch pad memory 218 can communicate via a local interface, instead of the internal interface 220.

The DMA controllers 214 can be configured to control movements of data between the model description table memory 216 and the sampling module 212, and/or between the model description table memory 216 and the external memory 204. The DMA controllers 214 are configured to provide the model description table to the sampling module 212 quickly so that the amount of idle time for sampling units 230A-230C is reduced. To this end, the DMA controllers 214 can be configured to schedule data transfer so that the idle time of the sampling units 230A-230C is reduced. For example, when a sampling unit 230 is generating a sample using a set of factors, the DMA controller 214 can preload memory for a next set of computations for generating a sample using a different set of factors.

In some embodiments, the controller 228 is configured to coordinate operations of at least the sampling module 212, the instruction memory 226, the DMA controllers 214, the model description table memory 216, and the scratch pad memory 218. The controller 228 can be configured to assign a sampling unit 230 to generate a sample for a particular variable in the graphical model. The controller 228 can also be configured to determine a temporal order in which the sampling units 230A-230C generate samples for variables of interest. This way, the controller 228 can generate one or more data samples that are statistically consistent with the probability distribution represented by the graphical model.

The model description table memory 216, the scratch pad memory 218, and the instruction memory 226 can include a non-transitory computer readable medium, including static random access memory (SRAM), dynamic random access memory (DRAM), flash memory, a magnetic disk drive, an optical drive, a programmable read-only memory (PROM), a read-only memory (ROM), or any other memory or combination of memories. The external memory 204 can also include a non-transitory computer readable medium, including static random access memory (SRAM), dynamic random access memory (DRAM), flash memory, a magnetic disk drive, an optical drive, a programmable read-only memory (PROM), a read-only memory (ROM), or any other memory or combination of memories.

The front-end interface 222, the system interface 206, and the internal interface 220 can be implemented in hardware to send and receive signals in a variety of mediums, such as optical, copper, and wireless, and in a number of different protocols some of which may be non-transient.

The computing device 200 includes a number of elements operating asynchronously. For example, the DMA controllers 214 and the sampling module 212 do not necessarily operate synchronously with each other. Thus, there is a potential for memory access collisions possibly resulting in memory corruption. In some examples, a synchronization mechanism uses information embedded in instructions and/or residing in synchronization registers to synchronize memory accesses, thereby avoiding collisions and memory corruption. A synchronization mechanism is disclosed in more detail in U.S. Patent Publication No. 2012/0318065, by Bernstein et al., filed on Jun. 7, 2012, which is hereby incorporated by reference in its entirety.

In some embodiments, the reconfigurable accelerator 208 can be configured to generate a sample in three steps. In the first step, the reconfigurable accelerator 208 can retrieve a model description table and provide the model description table. In the second step, the reconfigurable accelerator 208 can compute a sampling distribution based on the graphical model and the variable for which the sample is generated. Then the reconfigurable accelerator 208 can provide the sampling distribution to the sampling module 212. And in the third step, the sampling module 212 can generate a sample based on the sampling distribution computed in step 304.

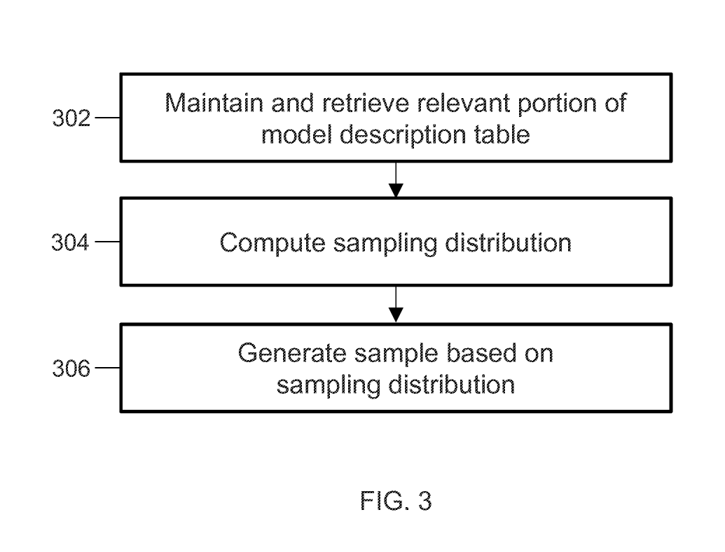

FIG. 3 illustrates a process of generating a sample using a reconfigurable accelerator in accordance with some embodiments. In step 302, the reconfigurable accelerator 208 is configured to maintain and retrieve relevant portions of a model description table. In some embodiments, the model description table can be maintained in external memory 204; in other embodiments, the model description table can be maintained in model description table memory 216 in the reconfigurable accelerator 208. In some cases, the model description table can be maintained in external memory 204 when the model description table is too big to fit in the model description table memory 216.

In step 304, the reconfigurable accelerator 208 can compute a sampling distribution for the sampling variable. The sampling distribution can be computed by combining values from factor table slices. Assuming that the distributions are expressed in the log domain (typically unnormalized negative log values, which correspond to energy), then this combination can involve a summation of table slices associated with each factor.

In step 306, the sampling module 212 can generate a sample in accordance with the sampling distribution. In some embodiments, the sampling module 212 can generate the sample using a CDF method.

In other embodiments, the sampling module 212 can operate in a streaming mode to generate a sample. In particular, the sampling module 212 can be configured to generate a sample using a Gumbel distribution method. The streaming mode of data sampling can allow the sampling module 212 to reduce the amount of local memory needed to generate a sample at the expense of additional computations per sample. Because a large amount of required local memory can incur a large area overhead in the reconfigurable accelerator 208, the reduced amount of required local memory in the streaming mode can be attractive even at the expense of additional computations per sample.

Memory bandwidth can be important for providing a high performance sampling hardware accelerator. Where the model description table is small, the model description table memory 216 can be structured to maximize the rate of access to the model description table. When the model description table is stored in the external memory 204, the access rate of the model description table can be limited by a speed of the external memory interface. In some cases, the reconfigurable accelerator 208 can maintain a cache to store portions of the model description table locally during the course of the computation. This way, the reconfigurable accelerator 208 can hide the limited speed of the external memory interface.

In some embodiments, the reconfigurable accelerator 208 may use only a small portion of the model description table to generate a sample for a sampling variable. The small portion of the model description table can include the probability associated with the current values of the sampling variable's neighboring variables (e.g., the current samples of variables in the Markov blanket of the sampling variable).

In some cases, a model description table for a factor of a graphical model can be considered as a tensor, with a tensor dimension equal to the number of variables in the factor, and the length of each dimension equal to the domain size of the corresponding variable.

When a reconfigurable accelerator 208 fixes sample values of all variables except the one currently being sampled (hereinafter a sampling variable), then the reconfigurable accelerator 208 can retrieve only a one-dimensional slice of the factor table. This slice is along the dimension associated with the variable being sampled. This can be beneficial for a large model description table. Any particular access to a slice retrieves only a small fraction of the entire table. This can reduce the memory bandwidth to perform a memory access compared to, for example, retrieving the entire model description table.

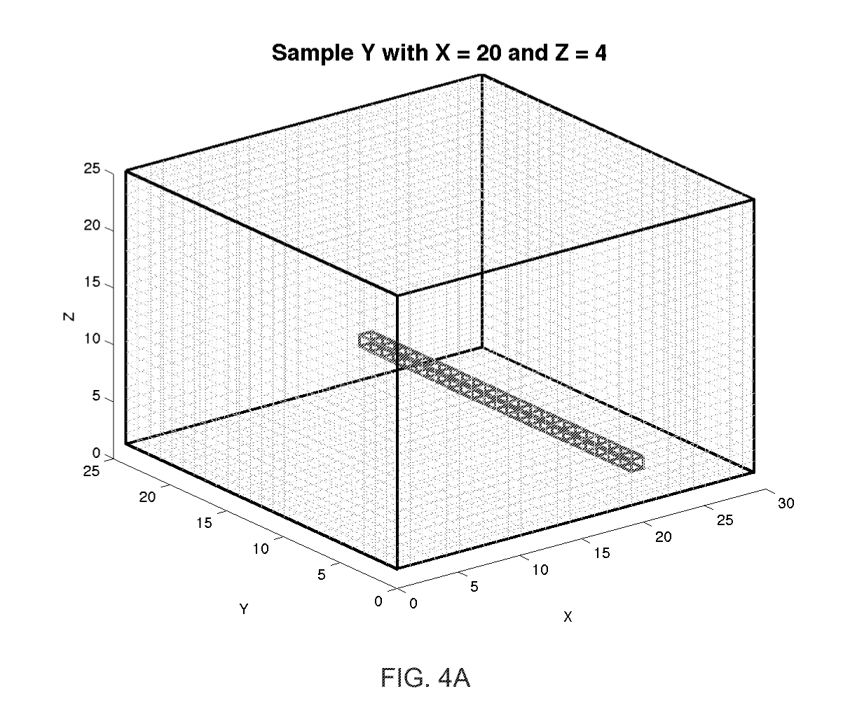

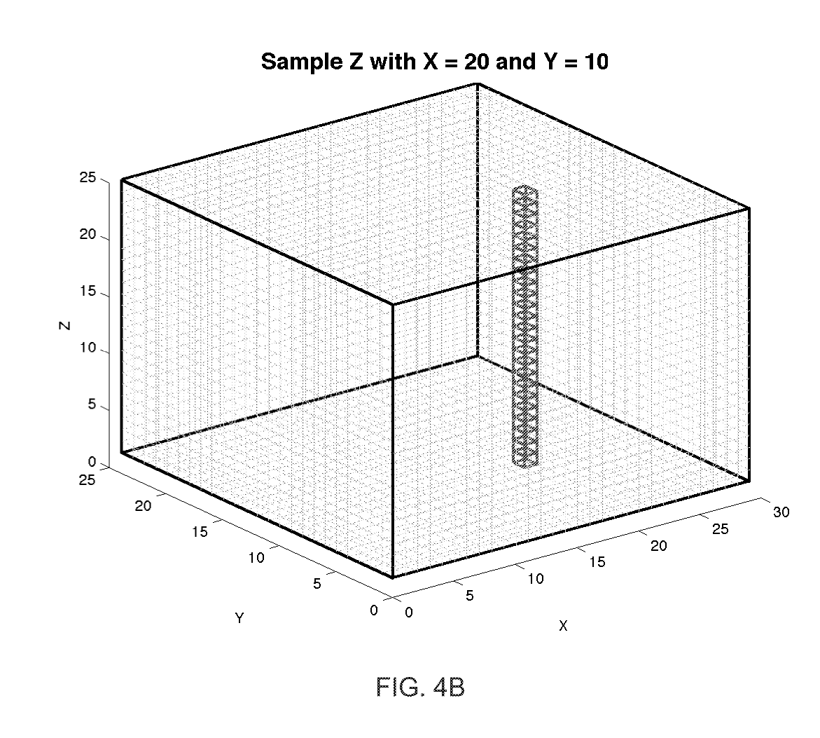

FIGS. 4A-4B illustrate a one-dimensional slice of a three-dimensional factor table in accordance with some embodiments. Each of FIGS. 4A-4B represents a factor table corresponding to a factor with three variables X, Y, and Z. The factor table is represented as a multidimensional tensor, in this case in three dimensions. FIG. 4A shows an example of a one-dimensional slice of the factor table that is retrieved when sampling the variable Z given fixed values of X and Y; FIG. 4B shows an example of a one-dimensional slice of the factor table retrieved when sampling Y given fixed values of X and Z.

This ability to retrieve only a portion of a factor table can influence a caching mechanism of the reconfigurable accelerator 206. In particular, the ability to retrieve only a one-dimensional slice of a factor table can influence when and whether the reconfigurable accelerator 206 locally caches some or all of a factor table, since copying the entire factor table generally incurs significantly more bandwidth than accessing a single slice of the factor table.

In some embodiments, the model description table can be stored in the external memory 204 or the model description table memory 216 in a raster scanning order. A raster scanning order can include an ordinary order in which bits are stored in a multidimensional array. For example, the raster scanning order can include an order in which a multidimensional array is sequenced through in an ordinary counting order, where each dimension is incremented when the previous dimension increments beyond its last value and wraps back to its first value. If the factor table is stored in a raster scanning order, then the dimension along which the slice is retrieved can determine the stride of successive accesses in memory, while the value of the neighboring variables determines the starting position in memory.

In some embodiments, the model description table can be too large to fit in the model description table memory 216 and can only be stored in the external memory 204. In such cases, the rate of access can be limited by the maximum data transfer rate of the front-end interface 222. When a given sampling operation requires access to multiple factors stored in the external memory 204, then the front-end interface 222 is configured to carry out the accesses for all of these factors. This can limit the maximum sampling speed, especially when a memory access rate exceeds the bandwidth of the front-end interface 222.

Because the external memory 204, for example, the DRAM, can exhibit the highest memory access rate when reading a contiguous block of locations, the access rate can depend on the stride of successive accesses. Unfortunately, for a given raster scan order for a model description table, only one dimension of the model description table is contiguous. This means that the external memory 204 is most efficient when sampling one of the variables associated with a model description table. For all other variables, the access rate would be significantly slower.

In some embodiments, to address the issues with memory stride directions, the external memory 204 can include a plurality of memory modules, each memory module configured to store a copy of the entire model description table but in a different bit order so that each copy of the table has a different variable dimension that is stored contiguously. Such a redundancy scheme can be less efficient in terms of storage space, but more efficient in speed.

In some embodiments, a model description table can be stored in the external memory as a default configuration, including a model description table that, during some period of time, may be copied to the model description table memory 216. In other embodiments, even when an entire model description table does not fit in the model description table memory, it may be beneficial to cache a portion of the model description table in the model description table memory. This would be the case if it can be determined that a particular portion of the model description table is likely to be used several times before it is no longer needed.

In other embodiments, for a model description table that fits in the model description table memory 216 and will be used many times while there, it may be beneficial to copy the entire model description table to the model description table memory. The model description table memory 216 can have several potential benefits in comparison with external memory 204. First, the model description table memory 216 can be completely random access. This means that accessing a slice of a factor table across any dimension of the table, and thus any arbitrary stride, can be equally fast. Second, access to the model description table memory 216 can be made arbitrarily wide, potentially allowing much greater memory bandwidth. And finally, the model description table memory 216 can be broken up into many distinct banks, allowing independent addressing of many locations simultaneously. Unfortunately, the model description table memory 216 is limited to a smaller storage size compared to the external memory 204. Therefore, the model description table memory 216 can only be able to fit a relatively small model description table or small portions of a larger model description table.

In some embodiments, the sampling units 230 and the model description table memory 216 can communicate via a flexible memory interface. This can be especially useful when the model description table memory 216 includes a plurality of memory banks The flexible memory interface can allow the sampling units 230 to communicate with the model description table memory 216 so that the sampling units 230 can receive data from different portions of the model description table at different times.

The flexible memory interface can include a wide bandwidth memory fabric that can allow many simultaneous accesses between sampling units 230 and memory banks. In some embodiments, the flexible memory interface can include a crossbar switch. The crossbar switch can provide a lot of flexibility, but it may be prohibitive in complexity. In other embodiments, the flexible memory interface can include a fat-tree bus architecture. In other embodiments, the flexible memory interface can include a network-on-a-chip configuration, with multiple network hops from the model description table memory 216 to the sampling units 230 and vice versa.

In some embodiments, the sampling module 212 is configured to generate a sample in a streaming mode (discussed below). For example, the sampling module 212 can use a Gumbel distribution method to generate a sample in a streaming mode. In this case, the reconfigurable accelerator 208 can use a summation computation module to perform the summation of table slices in a streaming manner.

In some cases, the summation computation module can perform the summation in a point-wise streaming manner. In other words, the summation computation module can sum each successive table slice element before moving on to the next table slice element. In this case, the summation computation module assumes that values of table slices are interleaved element-by-element across all table slices. When table slices are retrieved from the model description table memory 216, this element-by-element interleaving may be possible and desirable.

In other cases, the summation computation module can perform the summation in a block-wise streaming manner. In a block-wise summation approach, the summation computation module can receive a block of a model description table, which may include a plurality of elements, at a time and compute a running sum of the received blocks over time. Once the summation computation module sums blocks across all inputs, then the summation computation module can provide the result to the sampling module 212 and the summation computation module moves on to the next block of elements. In this case, the summation computation module assumes that table slices across inputs are interleaved block-by-block rather than element-by-element. In this block summation approach, the summation computation module can maintain a running sum of blocks, which incurs no more than a single block of storage space and no more, regardless of the domain size of the variable. Therefore, the summation computation module operating in the block-wise streaming manner can still be memory efficient compared to the summation computation module operating in a regular non-streaming manner. The block-wise summation can be especially useful when the table slices are retrieved from the external memory 204, such as DRAM, where block accesses can be much more efficient than random access, or when the word size of the model description table memory 216 is larger than the size of each vector element.

In some embodiments, the summation computation module can include a centralized adder and an accumulator. In some cases, the entire accelerator 210 can include one centralized adder and one accumulator. In such cases, all of the input slices from either the model description table memory 216 or the external memory 204 can be provided to the centralized adder over the internal interface 220, and the centralized adder can use the block-wide accumulator to keep track of the running sum of the elements or blocks of table slices. In other cases, each sampling unit 230 can include a centralized adder and an accumulator. For example, each sampling unit 230 receives a slice of a factor table and provide the table slice to the centralized adder. Subsequently, the centralized adder uses the block-wide accumulator to keep track of the running sum of the elements or blocks of the table slice.

In other embodiments, the summation computation module can include distributed adders that are configured to compute partial sums in parallel. If all sources of table slices happened to be from different memory banks (either in the model description table memory 216 or the external memory 204), then the adders of the summation computation module can be distributed along a memory interface between the memory and the sampling unit 230.

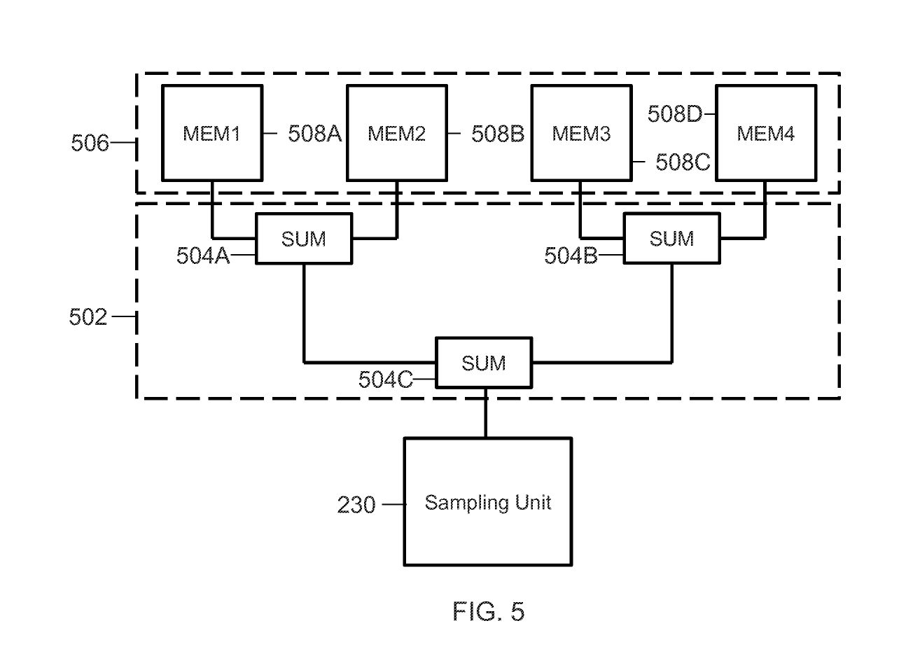

FIG. 5 illustrates a summation computation module having distributed adders in accordance with some embodiments of the disclosed subject matter. FIG. 5 includes a summation computation module 502 having a plurality of distributed adders 504A-504C, memory 506 having a plurality of memory banks 508A-508D, and a sampling unit 230. When each table slice resides in a different one of the plurality of memory banks 508, then the table slices can be retrieved simultaneously (or substantially simultaneously) from the plurality of memory banks 508, and the retrieved table slices can be added while being transferred to the sampling unit 230. This configuration is referred to as a summation tree.

When the memory 506 includes a sufficient number of memory banks 508, and when each table slice resides in a distinct memory bank, then the summation of the table slices in the summation tree can be done in approximately log N clock cycles (assuming a single cycle per sum), instead of N clock cycles if they are interleaved and streamed into a single central adder as described above, where N is the number of variables in the Markov blanket of the sampling variable. If two or more table slices come from the same memory bank, then a combination of a summation tree and sequential summing can be used. Specifically, table slices from the same bank can be summed sequentially, and they can be subsequently added to other table slices from other memory banks using a summation tree.

A potential advantage of using summation trees is that it allows the summations to be physically distributed so that they are local to each memory bank rather than centralized. Doing this has the advantage of reducing the bandwidth requirements of the memory interfaces. Specifically, after each intermediate summation, the resulting data rate is a fraction of the original data rate of the slices being read from memory. The fraction is the inverse of the number of inputs that have already been summed to that point. In this way, the summing blocks could be incorporated into a hierarchical bus structure that connects from all of the memory banks (internal and external) to a sampling unit 230.

In some embodiments, when the sampling module 212 includes more than one sampling unit 230, there could be more than one such sampling tree that includes intermediate distributed adders. This hierarchical structure of distributed adders can be referred to as a multi-summation tree. Depending on the location of the table slices in the memory 506, the multi-summation tree can allow multiple sampling units 230 to operate simultaneously. The multi-summation tree can improve the memory access speed, which is slowed only by memory collisions, which occurs when table slices destined to different sampling units 230 share the same memory bank.

In some embodiments, the sampling module 212 can include a large number of sampling units 230 to handle a large number of sampling distribution streams that can be computed simultaneously. In some cases, the reconfigurable accelerator 208 can provide sampling distributions to the sampling units 230 at a rate determined by the memory bandwidth and the number of variables in a Markov blanket of a sampling variable. The maximum sampling rate of a sampling unit 230 can be attained when the number of variables in the Markov blanket is 1.

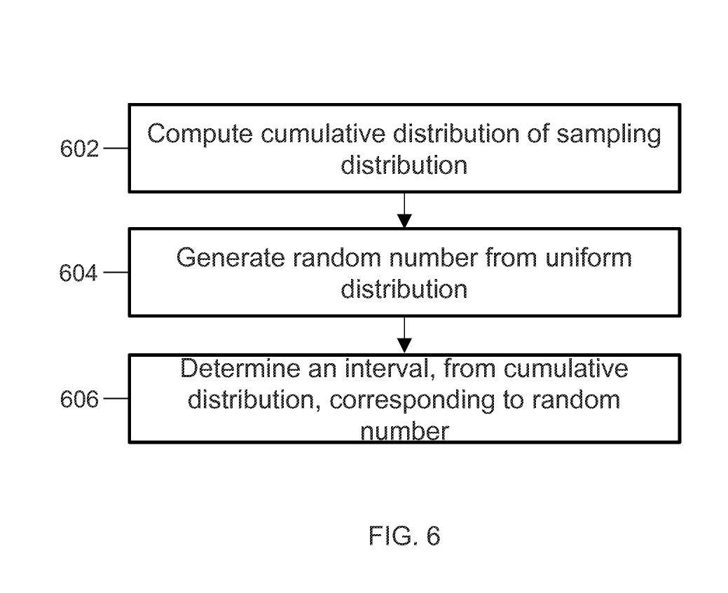

As discussed above, a sampling unit can be configured to generate a sample using a CDF method. FIG. 6 illustrates how a sampling unit generates a sample using a CDF method in accordance with some embodiments. In step 602, the sampling unit can be configured to compute a cumulative distribution of the sampling distribution, having a plurality of bins.

In step 604, the sampling unit can be configured to generate a random number from a uniform distribution. In some embodiments, the random number can be generated using a random number generator (RNG). In some embodiments, each sampling unit 230 can include a RNG. The RNG can include a plurality of linear feedback shift register (LFSR) sequence generators. In some cases, the plurality of LFSR sequence generators can be coupled to one another in series. The RNG in each sampling unit 230 can be initialized to a random state by the host system 202 on initialization of the reconfigurable accelerator 208. The number of LFSR sequence generators can be selected so that the LFSR sequence generators can generate sufficient number of random numbers per unit time to serve each sampling distribution received at a maximum rate. In some embodiments, the RNG can include a plurality of LFSR sequencers running in parallel. In some embodiments, the number of LFSR sequencers running in parallel can depend on a precision of the RNG.

In step 606, the sampling unit can be configured to determine the bin, from the cumulative distribution, corresponding to the random number. For example, as described above, the sampling module can determine the bin whose corresponding cumulative distribution value is greater than the random number and whose interval value is the smallest of bins whose corresponding cumulative distribution values are greater than the random number. The determined bin (or the interval corresponding to the bin) is the sample generated in accordance with the sampling distribution.

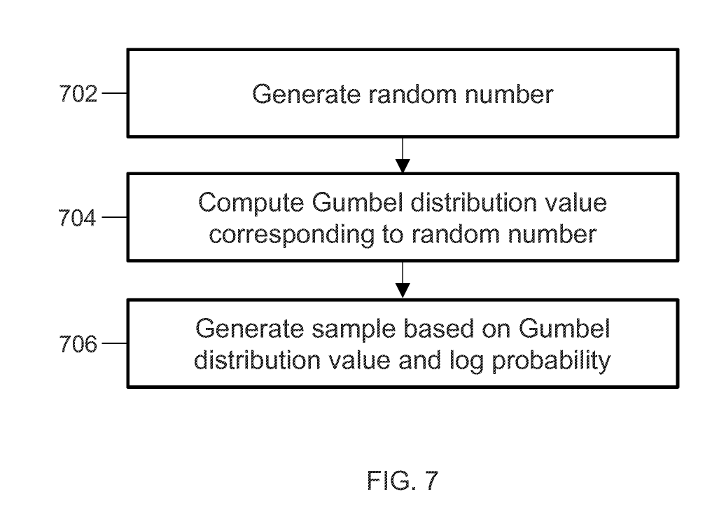

FIG. 7 illustrates an operation of a sampling unit in a streaming mode in accordance with some embodiments. In step 702, the sampling unit 230 can generate a random number. In some embodiments, the random number can be generated using a random number generator (RNG).

In step 704, the sampling unit 230 can compute a Gumbel distribution value of the generated random number. In some embodiments, the sampling unit 230 can generate a Gumbel distribution value of the generated random number using a Gumbel distribution generator. For example, the sampling unit 230 can provide a random number generated by the RNG to the Gumbel distribution generator.

F(x)=e^{-e}^{^{−x}} (13)

Then, the Gumbel distribution generator can compute −log(−log( )) of the received random number F(x) to generate a Gumbel distribution value G=x. In some embodiments, the Gumbel distribution generator can be configured to have at least 4 bits of accuracy. In other cases, the Gumbel distribution generator can be configured to have at least 8 bits of accuracy. In other cases, the Gumbel distribution generator can be configured to have at least 16 bits of accuracy.

In step 706, the sampling module 212 is configured to receive synchronized streams of an energy value E associated with a sampling distribution (e.g., a negative log of the sampling distribution) and the computed Gumbel distribution value, subtract the two values, and maintain a running minimum value of the difference of two values and the corresponding minimum index k⁺:

$${k}^{+} = {arg min {E}_{k}}_{k} - {G}_{k} , \\ k = 0 … {k}^{t} \qquad ( 14 )$$

where k^{t} is the current index in the streamed values Eₖ and Gₖ. This operation does not involve storing any values of Eₖ or Gₖ that have already been used. When the input stream is complete, the resulting minimum index Vis the value of the generated sample, which is passed to (or made available to) an application that uses the generated sample.

In some embodiments, the sampling module 212 can be configured to compute the minimum index k⁺ by the following relationship:

$${k}^{+} = {arg min Ω ( {E}_{k} )}_{k} - {G}_{k} , \\ k = 0 … {k}^{t} \qquad ( 15 )$$

where I can be an appropriate function that converts an entry in a factor table into an appropriate energy value. For example, the function I can include a linear function, a quadratic function, a polynomial function, an exponential function, or any combinations thereof

In some embodiments, the sampling module is configured to perform “hogwild” Gibbs sampling. Hogwild Gibbs sampling refers to Gibbs sampling that is configured to parallelize the generation of samples without considering dependency of variables in the graphical model 100. For example, hogwild Gibbs sampling ignores certain preconditions of Gibbs sampling, for instance, that two variables that share a common factor (e.g., the variables that are in each other's Markov blanket), should not be updated together. Although hogwild Gibbs sampling does not guarantee convergence to the exact distribution, the hogwild Gibbs sampling enables more parallelism and is often sufficient in practice.

For applications in which the domain size of variables is modest, the sampling module can use the CDF method to generate a sample. In the CDF method, storage is needed for the sampling distribution over the entire domain of the variable, but the computation itself is simpler (as described above) and for each sample, only a single random number is needed. This could significantly reduce the total number of random number generators needed. Therefore, the sampling module 212 configured to use a CDF method can include only one (or a small number of) random number generator, and it can be shared across multiple sampling units 230. As discussed above, when the variables are binary, then the sampling module 212 can use a variant of the CDF method, as described above, to even more efficiently generate samples.

For applications in which the domain size of variables is large, the sampling module can use the streaming mode (e.g., the Gumbel distribution method) to generate a sample. As discussed above, the Gumbel distribution method does not involve storing any values of Eₖ or Gₖ that have already been used. Therefore, the sampling module can use substantially less memory compared to the CDF method.

For applications in which the domain size of variables is very large, the sampling module can use other types of sampling methods. In the Gumbel distribution method or the CDF method, the amount of computation to generate a sample scales in proportion to the domain size. When the domain size of the variables is particularly large, it might be preferable to use Markov Chain Monte Carlo (MCMC) methods such as slice sampling, or the Metropolis-Hastings algorithm (as described above), in which the computation is not directly related to the domain size. In some cases, the sampling module 212 can include a plurality of sampling units 230, each tailored to a particular sampling method. Since some problems may require variables with a variety of domain sizes, each sampling unit 230 can be assigned to generate a sample for variables with an appropriate domain size.

In some embodiments, operations in the reconfigurable accelerator 208 can be coordinated using a controller 228. In particular, the controller 228 can be configured to coordinate the order of computation and data transfers. In some cases, the controller 228 can be configured to coordinate operations of at least the sampling units 230 in the sampling module 212, model description table memory 216, DMA controllers 214, and external memory 204.

In some embodiments, certain aspects of operations can be pre-computed at compile time and loaded to the controller 228 so that the complexity of the controller 228 can be reduced. These include:
Scan order: The controller 228 can be programmed with the order in which variables in a graphical model 100 are sampled, which is referred to as a scan order. The scan order can be deterministic or random. However, even if the scan order is random, the scan order can be pre-determined and loaded to the controller 228.
Graph-level parallelism: The controller 228 can be programmed with which variables can be updated simultaneously without violating the requirements for proper Gibbs sampling. The compiler can consider this problem as a graph-coloring problem, in which a graph is segmented into groups where each element of a group shares no neighboring variables with any other element in the same group.
Model description table locality: The controller 228 can be programmed with which portions of the model description table can be loaded into the model description table memory 216 during certain portions of the scan so that they will be available locally when some or all of the corresponding variable updates are executed. This operation can include a determination of which existing portions of the model description table in the model description table memory 216 can be removed and be replaced by other portions of the model description table. The controller 228 is configured to leverage existing portions of the model description table in the model description table memory 216 as much as possible (and as long as possible) before overriding them using other portions of the model description table.
Moving or replicating portion of a model description table: The controller 228 can be programmed with when it would be beneficial to move or copy a portion of the model description table into a different memory bank to reduce the total memory collision rate by maximizing the number of accesses that can be from distinct memory banks

In other embodiments, the controller 228 can be configured to determine some or all of these aspects at run time to allow a more flexible or adaptive operation. For example, model description table locality could be managed through a memory cache, where the copy into the model description table memory 216 is done only on demand as a given table is needed, and a rule is applied to determine where to copy the table and what table or tables it might replace.

In some embodiments, the controller 228 may decide to cache only portions of a model description table. For example, when the model description table is too large to fit entirely in the model description table memory 216, or when the model description table would remove too many other tables already in the cache, then the controller 228 may decide to cache only portions of a model description table (e.g., a subset of factor tables that together form the model description table). As another example, when some portions of the model description table would not be used frequently enough to justify the time and bandwidth used to copy the entire table into the cache, then the controller 228 may decide to cache only portions of the model description table that would be used frequently. Since the portions of a model description table that are actually needed depend on the current sample values of neighboring variables, such partial caching may not be predetermined at compile time. Therefore, the controller 228 can be configured to determine, in real time, which portions of a model description table should be cached.

In some embodiments, certain portions of a model description table are used more commonly than others. These would correspond to values of neighboring variables that have a higher probability in the probabilistic model. In this case, the controller 228 can determine to maintain these portions of the model description table in the cache or in the model description table memory 216 to allow for a more efficient memory access.

In some embodiments, the controller 212 can include a mechanism for detecting whether a slice of a factor table is locally stored at the model description table memory 216, and if so, where in the model description table memory 216 the slice of the factor table is located. While a traditional caching mechanism could be used, the controller 212 can be configured to implement an application-specific mechanism that is aware of the model description table structure and might be based, for example, on ranges of the corresponding variable values.

In some embodiments, the reconfigurable accelerator 208 can be configured to perform Gibbs sampling for a graphical model with continuous variables. As described above, the continuous variable Gibbs sampling can be performed using a specialized sampling unit 230 for specific parameterized distributions or using a more generic sampling unit 230 configured to perform more general sampling methods, such as slice sampling or Metropolis-Hastings sampling.

In some embodiments, the reconfigurable accelerator 208 can include one or more sampling units 230 for continuous variables operating in parallel with sampling units 230 for discrete variables. The controller 228 can be configured to coordinate discrete variable sampling units 230 and the continuous variable sampling units to make an effective use of parallel computation and to control the sequence of operation to ensure that the Gibbs sampling is properly performed.

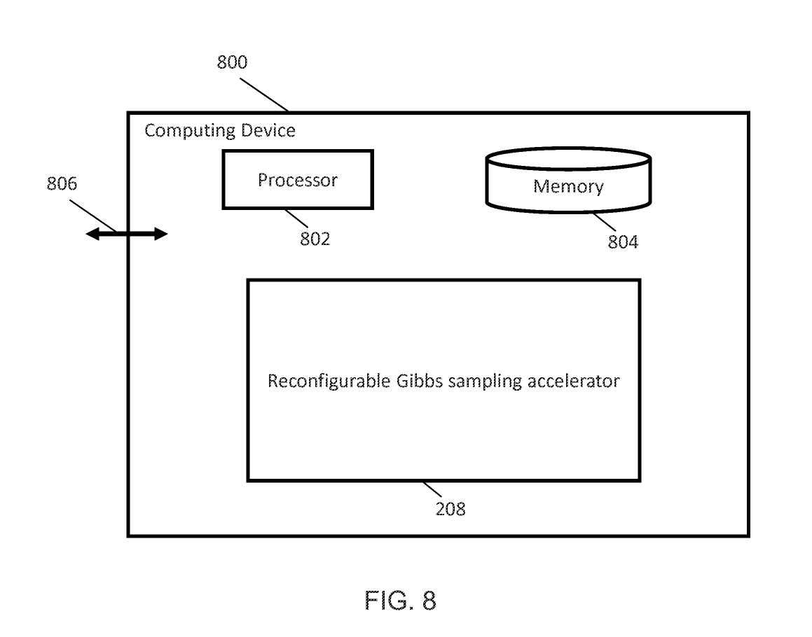

The disclosed apparatus can include a computing device. The computing device can be a part of a larger system for processing data. FIG. 8 is a block diagram of a computing device in accordance with some embodiments. The block diagram shows a computing device 800, which includes a processor 802, memory 804, one or more interfaces 806, and a reconfigurable sampling accelerator 208. The computing device 800 may include additional modules, fewer modules, or any other suitable combination of modules that perform any suitable operation or combination of operations.

The computing device 800 can communicate with other computing devices (not shown) via the interface 806. The interface 806 can be implemented in hardware to send and receive signals in a variety of mediums, such as optical, copper, and wireless, and in a number of different protocols some of which may be non-transient.

In some embodiments, the reconfigurable sampling accelerator 208 can be implemented in hardware using an application specific integrated circuit (ASIC). The reconfigurable sampling accelerator 208 can be a part of a system on chip (SOC). In other embodiments, the reconfigurable sampling accelerator 208 can be implemented in hardware using a logic circuit, a programmable logic array (PLA), a digital signal processor (DSP), a field programmable gate array (FPGA), or any other integrated circuit. In some cases, the reconfigurable sampling accelerator 208 can be packaged in the same package as other integrated circuits.

In some embodiments, the controller 228 in the reconfigurable sampling accelerator 208 can be implemented in hardware, software, firmware, or a combination of two or more of hardware, software, and firmware. An exemplary combination of hardware and software can include a microcontroller with a computer program that, when being loaded and executed, controls the microcontroller such that it carries out the functionality of the controller 228 described herein. The controller 228 can also be embedded in a computer program product, which comprises all the features enabling the controller 228 described herein, and which, when loaded in a microcontroller is able to carry out the described functions. Computer program or application in the controller 228 includes any expression, in any language, code or notation, of a set of instructions intended to cause a system having an information processing capability to perform a particular function either directly or after either or both of the following a) conversion to another language, code or notation; b) reproduction in a different material form. The controller 228 can be embodied in other specific forms without departing from the spirit or essential attributes thereof.

In some embodiments, the computing device 800 can include user equipment. The user equipment can communicate with one or more radio access networks and with wired communication networks. The user equipment can be a cellular phone having telephonic communication capabilities. The user equipment can also be a smart phone providing services such as word processing, web browsing, gaming, e-book capabilities, an operating system, and a full keyboard. The user equipment can also be a tablet computer providing network access and most of the services provided by a smart phone. The user equipment operates using an operating system such as Symbian OS, iPhone OS, RIM's Blackberry, Windows Mobile, Linux, HP WebOS, and Android. The screen might be a touch screen that is used to input data to the mobile device, in which case the screen can be used instead of the full keyboard. The user equipment can also keep global positioning coordinates, profile information, or other location information.

The computing device 800 can also include any platforms capable of computations and communication. Non-limiting examples include televisions (TVs), video projectors, set-top boxes or set-top units, digital video recorders (DVR), computers, netbooks, laptops, and any other audio/visual equipment with computation capabilities. The computing device 800 can be configured with one or more processors that process instructions and run software that may be stored in memory. The processor also communicates with the memory and interfaces to communicate with other devices. The processor can be any applicable processor such as a system-on-a-chip that combines a CPU, an application processor, and flash memory. The computing device 800 can also provide a variety of user interfaces such as a keyboard, a touch screen, a trackball, a touch pad, and/or a mouse. The computing device 800 may also include speakers and a display device in some embodiments. The computing device 800 can also include a bio-medical electronic device.

It is to be understood that the disclosed subject matter is not limited in its application to the details of construction and to the arrangements of the components set forth in the following description or illustrated in the drawings. The disclosed subject matter is capable of other embodiments and of being practiced and carried out in various ways. Also, it is to be understood that the phraseology and terminology employed herein are for the purpose of description and should not be regarded as limiting.

As such, those skilled in the art will appreciate that the conception, upon which this disclosure is based, may readily be utilized as a basis for the designing of other structures, methods, and apparatus for carrying out the several purposes of the disclosed subject matter. It is important, therefore, that the claims be regarded as including such equivalent constructions insofar as they do not depart from the spirit and scope of the disclosed subject matter. For example, some of the disclosed embodiments relate one or more variables. This relationship may be expressed using a mathematical equation. However, one of ordinary skill in the art may also express the same relationship between the one or more variables using a different mathematical equation by transforming the disclosed mathematical equation. It is important that the claims be regarded as including such equivalent relationships between the one or more variables.

Although the disclosed subject matter has been described and illustrated in the foregoing exemplary embodiments, it is understood that the present disclosure has been made only by way of example, and that numerous changes in the details of implementation of the disclosed subject matter may be made without departing from the spirit and scope of the disclosed subject matter.

1. An apparatus comprising:
a reconfigurable sampling accelerator configured to generate a sample of a variable in a probabilistic model, wherein the reconfigurable sampling accelerator comprises:
a sampling module having a plurality of sampling units, wherein a first one of the plurality of sampling units is configured to generate the sample in accordance with a sampling distribution associated with the variable in the probabilistic model;
a memory device configured to maintain a model description table for determining the sampling distribution for the variable in the probabilistic model; and
a controller configured to retrieve at least a portion of the model description table from the memory device, determine the sampling distribution based on the portion of the model description table, and provide the sampling distribution to the sampling module to enable the sampling module to generate the sample that is statistically consistent with the sampling distribution.

2. The apparatus of claim 1, wherein the first one of the plurality of sampling units is configured to generate the sample using a cumulative distribution function (CDF) method.

3. The apparatus of claim 2, wherein the first one of the plurality of sampling units is configured to compute a cumulative distribution of the sampling distribution, determine a random value from a uniform distribution, and determine an interval, corresponding to the random value, from the cumulative distribution, wherein the determined interval is the sample generated in accordance with the sampling distribution.

4. The apparatus of claim 1, wherein the reconfigurable sampling accelerator is configured to retrieve a one-dimensional slice of a factor table associated with the model description table from the memory device, and compute a summation of the one-dimensional slice to determine the sampling distribution.

5. The apparatus of claim 4, wherein the reconfigurable sampling accelerator is configured to compute the summation of the one-dimensional slice using a hierarchical summation block tree.

6. The apparatus of claim 1, wherein a second one of the plurality of sampling units is configured to generate a sample using a Gumbel distribution method.

7. The apparatus of claim 6, wherein the second one of the plurality of sampling units comprises a random number generator, and the second one of the plurality of sampling units is configured to:
receive negative log probability values corresponding to a plurality of states in the sampling distribution,
generate a plurality of random numbers, one for each of the plurality of states, using the random number generator,
determine Gumbel distribution values based on the plurality of random numbers,
compute a difference between the negative log probability values and the Gumbel distribution values for each of the plurality of states, and
determine a state whose difference between the negative log probability value and the Gumbel distribution value is minimum, wherein the state is the sample generated in accordance with the sampling distribution.

8. The apparatus of claim 7, wherein the second one of the plurality of sampling units is configured to receive the negative log probability values in an element-wise streaming manner.

9. The apparatus of claim 7, wherein the second one of the plurality of sampling units is configured to receive the negative log probability values in a block-wise streaming manner.

10. The apparatus of claim 7, wherein the random number generator comprises a linear feedback shift register (LFSR) sequence generator.

11. The apparatus of claim 1, wherein the controller is configured to determine an order in which variables in the probabilistic model are sampled.

12. The apparatus of claim 1, wherein the controller is configured to store the model description table in an external memory when a size of the model description table is larger than a capacity of the memory device in the reconfigurable sampling accelerator.

13. The apparatus of claim 1, wherein the memory device comprises a plurality of memory modules, and each of the plurality of memory modules is configured to maintain a predetermined portion of the model description table to enable the plurality of sampling units to access different portions of the model description table simultaneously.

14. The apparatus of claim 13, wherein each of the plurality of memory modules is configured to maintain a factor table corresponding to a factor within the probabilistic model.

15. (canceled)

16. The apparatus of claim 1, wherein the controller is configured to identify one of the plurality of representations of the model description table to be used by the sampling unit to improve a rate at which the model description table is read from the memory device.

17. The apparatus of claim 1, wherein the memory device comprises a scratch pad memory device configured to maintain intermediate results generated by the first one of the plurality of sampling units while generating the sample.

18. (canceled)

19. The apparatus of claim 1, wherein the memory device is configured to maintain the model description table in a raster scanning order.

20. A method comprising:
retrieving, by a controller from a memory device in a reconfigurable sampling accelerator, at least a portion of a model description table associated with at least a portion of a probabilistic model;
computing, at the controller, a sampling distribution based on the portion of the model description table;
identifying, by the controller, a first one of a plurality of sampling units in a sampling module for generating a sample of a variable in the probabilistic model; and
providing, by the controller, the sampling distribution to the first one of a plurality of sampling units to enable the first one of a plurality of sampling units to generate the sample that is statistically consistent with the sampling distribution.

21. The method of claim 20, further comprising:
computing a cumulative distribution of the sampling distribution,
determining a random value from a uniform distribution, and
determining an interval, corresponding to the random value, from the cumulative distribution, wherein the determined interval is the sample generated in accordance with the sampling distribution.

22. (canceled)

23. (canceled)

24. (canceled)

25. (canceled)

26. (canceled)

27. (canceled)

28. The method of claim 20, further comprising maintaining, in the memory device, a factor table in the model description table multiple times in a plurality of representations, wherein each representation of the factor table stores the factor table in a different bit order so that each representation of the factor table has a different variable dimension that is stored contiguously.

29. (canceled)
